(19) United States
(12) Patent Application Publication
(10) Pub. No.: US 2011/0277984 A1
(43) Pub. Date: Nov. 17, 2011

(54) Data Gathering Device and Method of Removing Contaminations from a Borehole Wall of a Well Before In Situ Gathering of Formation Data from the Borehole Wall

(75) Inventors: Rune Woie, Hafrsfjord (NO); Thor Martin Hegre, Hafrsfjord (NO)

(73) Assignee: Shore-Tec Consult AS, Hafrsfjord (NO)

(21) Appl. No.: 13/132,306

(22) PCT Filed: Dec. 14, 2009
(86) PCT No.: PCT/NO2009/000430

§ 371 Date: Jul. 29, 2011

(30) Foreign Application Priority Data
Dec. 22, 2008 (NO) 20085349

(51) Int. Cl. E21B 47/00; G01V 3/18

(52) U.S. Cl. 166/66; 73/152.02

(57) ABSTRACT

Data gathering device for in situ gathering of formation data from a borehole wall of a well in an open borehole comprises at least one movable measuring probe structured to be movable out from a well pipe to be able to establish contact with the borehole wall; at least one activation device structured in a manner allowing it to cause said measuring probe movement; at least one measuring sensor which, for measuring at least one formation-associated parameter, is connected to the measuring probe; and at least one data registration device which, for registration of measured parameters, is connected to the measuring sensor. The distinctive characteristic of the data gathering device is that it also comprises at least one suction chamber hydraulically connected to the measuring probe; wherein the suction chamber is structured in a manner allowing it to carry out non-motorized suction of contaminations from the borehole wall before the gathering of formation data is initiated; and wherein the suction chamber is connected to a release means for controlled activation of said suction. This suction removes said contaminations and thus brings about the best possible contact with the borehole wall during gathering of formation data.

### FIELD OF INVENTION

The present invention concerns a data gathering device connected to a well pipe and structured for in situ gathering of formation data from a borehole wall of a well. More specifically, the invention concerns a suction chamber in the data gathering device, wherein the suction chamber is structured for removal of contaminations from the borehole wall before said data gathering is initiated. The invention also concerns a method of removing contaminations from the borehole wall before initiating said data gathering.

This relates to gathering of formation data in so-called open wellbores, and also to gathering of formation data more or less continuously throughout the lifetime of a well.

In this context, said contaminations comprise mud filtrate normally covering the borehole wall, and also mud permeate and/or another well liquid which may have penetrated into the borehole wall and have contaminated the original formation fluid therein.

The invention is applicable in wells of any type. It may concern, for example, wells related to exploration and recovery of hydrocarbons, such as exploration wells, productions wells, injection wells, development wells, delineation wells and observation wells. Yet further, it may concern wells related to recovery of geothermal energy or freshwater. Moreover, it may concern vertical wells, deviation wells, horizontal wells or multi-lateral wells.

### BACKGROUND OF THE INVENTION

The background of the invention relates to the petroleum industry, and particularly relates to production of fluids from underground reservoirs.

When gas and/or liquid is/are produced from a hydrocarbon-bearing reservoir, pressure changes will arise in the reservoir. The size of the pressure changes, or the pressure gradient, will be defined partially by the particular production rate from the reservoir, but also by the quality of the reservoir rocks and their ability to communicate the particular fluid(s) within the reservoir, possibly between different reservoirs and/or reservoir layers. A reservoir consists of inhomogeneous rocks capable of exhibiting large vertical and/or horizontal variations in quality and flowability. The fluid recovery factor of a well may depend strongly on the particular fluid communication pattern in the reservoir. With respect to a layered reservoir, the drainage of singular reservoir layers may be affected more or less by any fluid communication between the reservoir layers. A limited fluid communication between the reservoir layers, as opposed to no such fluid communication, may therefore result in a very large difference in the recovery factor of the well. It is very important to acquire this type of reservoir information as early as possible so as to be able to estimate future production and reserve estimates, but also to be able to optimize a drainage strategy and well placement strategy when several wells are used in a course of recovery. In this context, it may also be important to be able to register other types of reservoir data, for example reservoir temperature and fluid composition, as well as changes in such reservoir data.

As such, there is a need in the petroleum recovery industry for being able to gather relevant reservoir data more or less continuously during the course of recovery, whereby a historical progress in said reservoir data may be established. Such a historical progress is very useful for being able to optimize the course both with respect to the recovery factor of the reservoir, and with respect to the operational profitability thereof. The invention may also be useful in context of production testing of exploration wells and delineation wells.

It is emphasized, however, that even though the background of the invention relates to the petroleum industry, there are obvious applications for the invention within other branches of industry wherein more or less continuous, in situ gathering of formation data may be of great significance, for example in context of geothermal wells or freshwater wells.

### PRIOR ART AND DISADVANTAGES THEREOF

Using data gathering tools attached to a logging cable (wireline) which is lowered temporarily into the particular place in an open, uncased wellbore for in situ gathering of formation data from the borehole wall of the well, constitutes prior art. This type of wireline operation is oftentimes referred to as “wireline logging”. Generally, the purpose of the wireline operation is to measure formation pressure and formation temperature, possibly also to acquire formation fluid samples brought to the surface of the well upon withdrawal of said tool. Such data gathering tools are oftentimes referred to as a RFT-tool (“Repeat Formation Tester”), MDT-tool (“Modular Formation Dynamics Tester”) or similar. Upon using such a data gathering tool, gathered formation data are typically transmitted to surface as electrical signals, and via said logging cable. Upon having run the data gathering tool down into the well and having temporarily fixed the tool against the borehole wall, a measuring probe is normally forced into the borehole wall so as to gain contact with the formation surrounding the wellbore. Formation fluid is then pumped into a chamber in the tool so as to be able to measure fluid pressure and fluid temperature, for example, possibly also to acquire a sample of the fluid. Possibly, this data gathering procedure may be carried out at several positions in the well. By so doing, the static pressure profile in the formation surrounding the wellbore may be measured, for example.

Alternatively, such a data gathering tool may be used to measure vertical fluid communication between a transmitter probe and a receiver probe which are forced into the borehole wall at a distance from one another. This is achieved by pumping out a fluid into the formation of the borehole wall, possibly by pumping formation fluid into the well, via the transmitter probe, whilst simultaneously observing the associated pressure changes in the receiver probe. The latter method, however, has large limitations with respect to rate and volume of the fluid being pumped. For this reason, it may frequently prove difficult to observe pressure changes in the receiver probe, which results in unreliable or absent measurements.

As an alternative to wireline runs, such data gathering tools may be attached to coiled tubing for insertion into a wellbore. Coiled tubing is readily used for insertion in deviation wells and horizontal wells.

Moreover, it is known to obtain formation pressure measurements via data gathering tools attached to a drill string. Such data gathering tools are oftentimes referred to as a MWD-tool (“Measurements While Drilling”) or a LWD-tool (“Logging While Drilling”).

Use of such cable-based or coiled tubing-based data gathering tools involves the significant disadvantage of the tools only providing time-specific formation data, i.e. they provide only a snapshot of the particular measuring parameter(s), and hence no historical progress of the parameter(s) during the lifetime of a reservoir. This is additional to having to initiate a comprehensive and expensive wireline operation or coiled tubing operation in order to render such data gathering possible.

Yet further, it is customary to install pressure- and temperature gauges in development wells. Even though such gauges measure the pressure in those intervals being produced from or injected into, they do not provide detailed pressure information from the individual intervals. Nor do such gauges provide information from formation zones located in vicinity of said production intervals or injection intervals.

In order to allow in situ gathering of formation data to be carried out, it is (as mentioned) customary to force a measuring probe into the borehole wall in order to gain contact with the formation surrounding the wellbore. In an open wellbore, the borehole wall will normally be covered by a layer of mud filtrate, especially in regions wherein the surrounding formation is porous and permeable. In addition, a mud permeate and/or another well liquid may have penetrated some distance into the borehole wall of such borehole regions.

Said mud filtrate, mud permeate and/or well liquid constitute(s) undesirable contaminations capable of disturbing, destroying or preventing such an in situ gathering of formation data from the borehole wall. An invasion of mud permeate and/or well liquid may contaminate the original formation fluid, whereas mud filtrate may constitute a barrier/plug which prevents sufficient contact with the formation surrounding the wellbore. Such contaminations may therefore represent a significant problem to the data gathering. It is therefore very important, perhaps crucial, that such contaminations are removed as much as possible before the gathering of formation data is initiated.

Thus, the present invention seeks to provide simple technical solutions for removing such contaminations before said data gathering is initiated.

With respect to the present invention, the following patent publications appear to represent the closest prior art:
WO 97/49,894 (Baker Hughes); and
U.S. Pat. No. 7,204,309 (Segura et al.).

Both publications concern downhole measuring of formation parameters in a well.

WO 97/49,894 describes a data gathering device for gathering of formation data via a measuring probe structured to be movable out from a casing. Among other things, the data gathering device comprises a combined measuring probe/measuring sensor which is hydraulically connected to the inside of the casing, and which may be displaced radially outwards until contact with a surrounding reservoir. In this extended position of use, fluid contact is achieved between the reservoir and the measuring sensor by virtue of reservoir fluid flowing into the casing via the combined measuring probe/measuring sensor. Such a fluid flow presupposes a driving pressure difference between the reservoir and the casing, and that the fluid pressure of the reservoir is higher than the fluid pressure of the casing. As such, this driving pressure difference provides for a forced fluid flow of the reservoir fluid, i.e. a fluid flow caused by an active pressure drive force. In order to break the barrier caused by mud filtrate, and in order to ensure fluid contact between the reservoir and the measuring sensor, an opening in the casing is required. Oftentimes, such an opening in the casing is undesirable or completely unacceptable in regions wherein the gathering of formation data is to be carried out. Therefore, the area of application of the data gathering device according to WO 97/49,894 is limited.

U.S. Pat. No. 7,204,309 describes a data gathering device for gathering of formation data via a measuring probe structured to be movable out from a drill string. Also in this publication, a forced fluid flow is required to be able to gather fluid-related formation data. An electric motor connected to a pump is used to supply hydraulic fluid to a piston which thus moves in a cylinder so as to suck in a formation liquid sample via said measuring probe. This form of suction is both motorized and forced. Thus, the suction is secondary insofar as it is caused by an active drive force provided by means of said electric motor and pump. The use of an electric motor and a pump, however, is complicated, technically speaking. This equipment also requires much space in the drill string, and the equipment has a high power requirement. Moreover, the pump according to U.S. Pat. No. 7,204,309 requires contact with surface. By using the present invention, on the other hand, it is not necessary to use a pump and a motor.

### OBJECTS OF THE INVENTION

The primary object of the invention is to avoid or reduce the above-mentioned disadvantage of the prior art for gathering of formation data from the borehole wall of a well.

A more specific object of the invention is to provide simple and efficient technical solutions for removal of said contaminations from the borehole wall of a well in an uncemented or “open” data gathering region of the borehole, and by means of ordinary well pipes being installed in a well. The removal of contaminations should be carried out before in situ gathering of formation data from the borehole wall is initiated.

### How the Objects are Achieved

Said objects are achieved by virtue of the features disclosed in the following description, the features of which the subsequent claims are based upon.

According to a first aspect of the invention, a data gathering device for a well pipe is provided, wherein the data gathering device is connected to the well pipe and is structured for in situ gathering of formation data from a borehole wall of a well in an open borehole.

According to this first aspect, the data gathering device comprises the following features:
at least one movable measuring probe structured to be movable at least out from the well pipe to be able to establish contact with the borehole wall;
at least one activation device structured in a manner allowing it to cause said measuring probe movement;
at least one measuring sensor which, for measuring at least one formation-associated parameter, is connected to the measuring probe; and
at least one data registration device which, for registration of measured parameters, is connected to the measuring sensor. The distinctive characteristic of the data gathering device is that it also comprises at least one suction chamber hydraulically connected to the measuring probe;
wherein the suction chamber is structured in a manner allowing it to carry out non-motorized suction of contaminations from the borehole wall before the gathering of formation data is initiated; and
wherein the suction chamber is connected to a release means for controlled activation of said suction. This suction removes said contaminations and thus brings about the best possible contact with the borehole wall during gathering of formation data therefrom.

In a first embodiment, the suction chamber may be comprised of a low-pressure chamber provided with a compressible medium arranged with a lower pressure than the particular formation pressure at the borehole wall;
wherein a pressure isolation means is disposed between the low-pressure chamber and the measuring probe for maintenance of the lower pressure in the low-pressure chamber; and
wherein a release means is connected to the pressure isolation means for controlled liberation of the pressure isolation means. This liberation provides for pressure communication between the low-pressure chamber and the measuring probe so as to bring about suction of contaminations from the borehole wall and into the low-pressure chamber.

Said pressure isolation means may be comprised of a movable seal plug sealing off an inlet to the low-pressure chamber. The term movable implies, in this context, a seal plug which, upon liberation, may be moved away from its seal seat so as to open the inlet to flow of contaminations into the low-pressure chamber. The seal plug is of a shape and composition suitable for this purpose, and which is adapted to the particular embodiment of the low-pressure chamber. Further, the seal plug may be connected to catch barbs for ensuring that the plug is movable in one direction only.

Upon using such a seal plug, said release means may comprise an electric coil operatively connected to a movable magnet;
wherein the magnet is connected to an operating body releasably connected to said seal plug for controlled holding and liberation of the seal plug; and
wherein the electric coil, upon activation, is structured in a manner allowing it to move the magnet and the operating body away from the seal plug for liberation of the seal plug.

Said operating body may be comprised of a rod, pin, strut or similar projecting out from the magnet and being releasably connected to a groove, notch or similar in the seal plug.

Moreover, the release means connected to the seal plug may be disposed in a cavity associated with the well pipe, the cavity of which may be formed as a chamber, pocket, recess, is groove or similar. Equipment for current supply, activation and/or control of the electric coil and the corresponding movement of its magnet, may be disposed in the same cavity as the release means, or in a separate cavity associated with the well pipe. Typically, such equipment will comprise electronic components and associated equipment, including electronic circuit boards, batteries and associated components, as well as attachment means and connection means for such equipment, etc. This equipment is structured for activation and potential control of said coil. If necessary or desirable, the coil may be structured for remote activation and potential control thereof.

For example, activation of the coil may be carried out by virtue of said electronic circuit board being programmed to send an activation current from said battery onto the coil at a specific point in time.

Alternatively, the circuit board may be programmed to transmit the activation current at a specific time-delay upon having set the measuring probe of the data gathering device against the borehole wall. This presupposes that the circuit board receives a signal confirming that the measuring probe has been set, for example by means of a signal transmitter which registers that the measuring probe has been set and then transmits a signal about this to the circuit board.

As a further alternative, the coil may be connected to a magnet switch activating said current supply to the coil when an external magnet is inserted into the well pipe and past the magnet switch. For example, the external magnet may be inserted via a so-called cementing plug in connection with cementation of the well pipe, or by means of wireline.

According to the first embodiment of the data gathering device, and as an alternative, said pressure isolation means may be comprised of a seal sealing off an inlet to said low-pressure chamber.

Upon using such a seal, said release means may comprise an electric coil operatively connected to a movable magnet;
wherein the magnet is connected to an operating body provided with a puncturing means for the seal;
wherein the puncturing means is disposed in vicinity of the seal; and
wherein the electric coil, upon activation, is structured in a manner allowing it to move the magnet, and hence the puncturing means of the operating body, towards the seal for puncturing of the seal.

In this context, the release means and the operating body may be of a type corresponding to that described in context of said seal plug.

For example, said puncturing means may be comprised of a tip, punch, knife or similar disposed at the free end of the operating body.

Upon using such a seal, and as an alternative, said release means may comprise a movable operating body formed from a shape-memory material;
wherein the operating body is provided with a puncturing means for the seal;
wherein the puncturing means is disposed in vicinity of the seal; and
wherein the shape-memory material is structured in a manner allowing it to be activated and extended upon reaching a temperature corresponding to the particular formation temperature at the borehole wall. This extension of the operating body causes the puncturing means to puncture the seal.

In order to avoid premature activation of the shape-memory material and an associated extension of the operating body, the operating body may, for example, be temperature-isolated so as to delay the heating of the shape-memory material.

For example, this shape-memory material may be comprised of a shape-memory metal or a shape-memory alloy. Such shape-memory materials constitute prior art and hence will not be discussed in further detail herein.

Further, the compressible medium in said low-pressure chamber may be comprised of air or another suitable gas.

In a second embodiment, the suction chamber may be comprised of a cylinder provided with a piston movably arranged within the cylinder;
wherein a downstream end portion of the cylinder is open to discharge;
wherein an upstream end portion of the cylinder is provided with a biasing means connected in a biasing manner to an upstream side of the piston; and
wherein a release means is releasably connected to the piston for controlled holding and liberation of the piston.

This liberation causes a biasing force in the biasing means to drive the piston in a downstream direction within the cylinder so as to bring about suction of contaminations from the borehole wall and into the cylinder.

According to this second embodiment, the release means may comprise an electric coil operatively connected to a movable magnet;
wherein the magnet is connected to an operating body releasably connected to the piston for controlled holding and liberation of the piston; and
wherein the electric coil, upon activation, is structured in a manner allowing it to move the magnet, and hence the operating body, away from the piston for liberation of the piston.

In this context, the release means and the operating body may be of types corresponding to those described hereinbefore.

Alternatively, the release means may comprise a movable operating body formed from a shape-memory material;
wherein the operating body is releasably connected to the piston for controlled holding and liberation of the piston; and
wherein the shape-memory material is structured in a manner allowing it to be activated and change the shape of the operating body to a piston-liberating shape upon reaching a temperature corresponding to the particular formation temperature at the borehole wall.

In this context, the shape-memory material of the operating body may be of types corresponding to those described hereinbefore. The operating body is also of such a form that it assumes, upon reaching said temperature, a changed shape allowing for liberation of said piston. When the operating body is in its inactive shape, it may be in releasable engagement with, for example, a groove, notch or similar in the piston. On the other hand, when the operating body is activated at said temperature, it will change its shape to a shape causing the operating body to disengage from the piston so as to liberate the piston.

Also here, the operating body may be temperature-isolated in order to delay the heating of the shape-memory material and hence avoid premature activation of the shape-change of the operating body.

Further, the biasing means according to this second embodiment may be comprised of, for example, a spring.

In a third embodiment, the suction chamber may be comprised of a cylinder provided with a piston movably arranged within the cylinder;
wherein a downstream end portion of the cylinder is open to discharge;
wherein an upstream side of the piston is connected to a piston rod formed from a shape-memory material; and
wherein the shape-memory material is structured in a manner allowing it to be activated and extended upon reaching a temperature corresponding to the particular formation temperature at the borehole wall. This temperature activation constitutes a release means causing the piston rod to be extended so as to drive the piston in a downstream direction within the cylinder and thus bring about suction of contaminations from the borehole wall and into the cylinder.

In this context, the shape-memory material of the piston rod may be of types corresponding to those described hereinbefore.

The piston rod of shape-memory material may possibly be temperature-isolated in order to delay the heating of the shape-memory material and thus avoid premature activation and shape-change of the operating body.

Yet further, the cylinder (suction chamber) according to the second and third embodiment may be connected to a flow delay means providing for a more even flow into the cylinder and also out of said open and downstream end portion of the cylinder. Such a delay means may be comprised of a flow restriction, for example a nozzle, disposed at the upstream or downstream end of the cylinder.

As an addition or alternative, and possibly in order to obtain a delayed starting motion of the piston of the cylinder, the cylinder may be fully or partially filled with an easily fusible material that will melt and deform gradually at a certain temperature, for example the particular formation temperature at the borehole wall. For example, the easily fusible material may be comprised of a suitable plastics material, wax material or of bitumen. Easily soluble sugar, which will gradually dissolve and deform, may also be used.

Furthermore, the measuring probe and the suction chamber of the data gathering device may be disposed in a protective housing connected to the well pipe, wherein the measuring probe is structured to be movable at least out of the housing for contact with the borehole wall.

In addition, at least one of said activation device, measuring sensor and the data registration device may be disposed in the housing.

The housing forms a completely or partially protective enclosure for the measuring probe and the suction chamber, possibly also for the activation device, the measuring sensor and/or the data registration device if disposed in the housing. The protective housing may be arranged in the pipe wall of the well pipe or on the outside of the well pipe. If arranged on the outside of the well pipe, the protective housing may, for example, be formed as an annular packer, a stabilizer, a jacket or a bulb.

According to a second aspect of the invention, a method of removing, in an open borehole, contaminations from a borehole wall of a well before initiating in situ gathering of formation data from the borehole wall is provided.

According to this second aspect, the method comprises the following steps:

(A) providing a well pipe with a data gathering device comprising:
at least one movable measuring probe;
at least one activation device connected to the measuring probe;
at least one measuring sensor connected to the measuring probe; and
at least one data registration device connected to the measuring sensor;
   (B) inserting the well pipe and its data gathering device into the well and down to a data gathering region in the open borehole;
   (C) for gathering of formation data, placing the data gathering device in a desired position in said region of the borehole;
   (D) activating the activation device and moving the measuring probe in a direction out from the well pipe and into the borehole wall for contact therewith;
   (E) by means of the measuring sensor, measuring at least one formation-associated parameter; and
   (F) by means of the data registration device, registering measured parameters from the measuring sensor. The distinctive characteristic of the method also comprises, in step (A), the following steps:
providing the data gathering device with at least one suction chamber structured in a manner allowing it to carry out non-motorized suction of contaminations from the borehole wall;
connecting the suction chamber to a release means for controlled activation of said suction; and
hydraulically connecting the suction chamber to the measuring probe.

Between steps (D) and (E), the method also comprises a step of releasing the release means so as to initiate said suction. This suction removes said contaminations and thus brings about the best possible contact with the borehole wall during the following gathering of formation data therefrom.

As for the rest, features of the data gathering device according to the first aspect of the present invention also apply to the method according to the second aspect of the invention.

Features and conditions concerning the very data gathering function of the present invention will now be described.

Given that the data gathering device comprises at least one measuring probe, at least one activation device, at least one measuring sensor and at least one data registration device, the data gathering device may be structured for gathering and registration of one, two or more formation-associated parameters.

Should said well pipe also be provided with several such data gathering devices, it is possible to acquire formation data, i.e. one, two or more formation-associated parameters, from several positions in the well, for example from different reservoirs and/or reservoir layers.

In this context, the data gathering device may be connected to the well pipe in various ways, which will be discussed in further detail hereinafter. For this purpose, a person skilled in the area will use ordinary attachments means, gaskets, bushings, materials, etc. known per se and which are suitable for the particular embodiment of the data gathering device. For this reason such means will not be discussed in further detail herein.

Moreover, the data gathering device may include ordinary electronic components and associated equipment known per se, including data storage means, for example memory chips, processors, data programs, data converters, signal transmission equipment, couplings and wires, gaskets, energy sources, for example batteries, protective devices and attachments means for such equipment, etc. Components and equipment in the data registration device may possibly be available in one or more units which possibly may be removed or replaced. Thus, one or more units, for example a memory chip and/or batteries, may be structured for liberation from the data registration device, whereas remaining components and equipment stay in the data gathering device. Such components and equipment are considered known to the person skilled in area, and hence will not be discussed in further detail herein. The skilled person will select components and equipment adapted to the particular embodiment and the particular type(s) of formation data to be gathered.

Depending on how the data gathering device is structured, it is possible to acquire continuous, regular or periodic transmission of gathered formation data to surface. Also this will be discussed in further detail hereinafter.

In one embodiment, said activation device may include:

(a) a biasing means connected to the measuring probe and biasing the measuring probe in a direction out from the well pipe; and
(b) a release means connected to the biasing means for releasing thereof.

For example, the biasing means may be comprised of a spring connected to the measuring probe and capable of being released by said release means.

In one embodiment, this release means may be comprised of a locking device in the form of a latch pin, cotter pin, lock washer or similar holding the spring in a biased position of rest. In a second embodiment, the locking device may be comprised of a shear pin severable through mechanical influence or pressure influence. In a third embodiment, the locking device may comprise a dissolvable material, for example aluminium, capable of being dissolved and disintegrated upon contact with a suitable solvent, for example an acid, for the locking pin material.

Corresponding or similar locking devices may also be used as a release means in connection with the suction chamber of the data gathering device.

The locking device may also comprise a shape-memory material of the above-mentioned type which, when activated, changes the form of the locking device to a shape suitable for release of said biasing means. For example, the shape-memory material is activated at the temperature that will exist at the particular well position for installation of the data gathering device. In order to avoid premature activation, also this locking device may be temperature-isolated so as to delay the heating of the shape-memory material.

In another embodiment, the release means may be comprised of an easily fusible material, for example a suitable plastics material or wax material, or of bitumen, which will melt and deform gradually at said temperature at the particular well position for the data gathering device. Easily soluble sugar, which will gradually dissolve and deform, may also be used.

As an alternative, the activation device may include a piston connected to the measuring probe so as to be able to cause said measuring probe movement. Most suitably, such a piston may be moved through pressure influence, for example through the influence of a hydraulic fluid, but also through mechanical influence should this be desirable. This presupposes that suitable force transmission connections are disposed onwards to the piston, which is considered to prior art to a person skilled in the area.

As another alternative, the activation device may include an extendible material structured in a manner allowing it to expand upon contact with an activation medium. In this context, the extendible material is connected to the measuring probe so as to be able to cause the measuring probe movement through expansion of the extendible material upon contact with the activation medium.

Thus, the activation medium may be comprised of an activation fluid conveyed onto the extendible material. As an example, the extendible material may be comprised of a swelling rubber or a swelling polymer, whereas the activation fluid may be comprised of a hydrocarbon fluid, for example oil, possible water or a saline solution.

As a further alternative, the activation medium may be comprised of an activation temperature that will exist at said borehole wall before in situ gathering of formation data, i.e. at the temperature that will exist at the installation position of the data gathering device in the well. In this context, the extendible material may comprise a construction including a shape-memory material of the above-mentioned types, the material of which will expand upon temperature activation. Also here this contruction may be temperature-isolated so as to delay the heating of the shape-memory material for the purpose of avoiding premature activation.

Further, said data registration device may be connected to the measuring sensor via a cabled or wireless connection. As an example, such a wireless connection may be comprised of a radio frequency connection. Besides, the data registration device may be attached to the inside of the well pipe or on the outside of the well pipe. Yet further, at least parts of the data registration device may be releasably attached so as to allow them/it to be removed or replaced. Thus, at least one data storage medium, for example a memory chip, may be replaced for further data gathering. If required or desirable, other of the above-mentioned components and/or equipment in the data registration device, for example batteries, may also be releasably attached for allowing them to be removed or replaced. For example, such components and/or equipment may be releasably placed in pockets, recesses, grooves or similar arranged on the inside or the outside of the well pipe. Via well intervention, for example cable-assisted well intervention, it is thus possible to carry out a periodical withdrawal and replacement of such components and/or equipment, for example memory chips and batteries.

The data registration device may also be structured in a manner allowing it to transmit gathered formation data to the surface of the well via a cabled connection or via a wireless connection. For example, the wireless connection may consist of a telemetry connection, a radio frequency connection or an acoustic connection. By so doing, it is possible to transmit formation data continuously or regularly to surface. This, however, will depend on how the data gathering device's electronics, processor and similar are set up.

Further, said measuring sensor may be attached to the inside of the well pipe or on the outside of the well pipe. Yet further, the measuring sensor may be releasably attached so as to allow it to be removed or replaced.

As mentioned, the measuring probe may be disposed together with the suction chamber in a protective housing connected to the well pipe. The protective housing may also include a measuring chamber for receiving formation fluid via the measuring probe, wherein the measuring sensor is connected to the measuring chamber for measuring at least one fluid parameter.

The measuring probe and the measuring sensor may possibly be assembled in a joint measuring element, for example a sleeve-shaped element, structured to be movable at least out of the housing. This joint measuring element may also include a measuring chamber for receiving formation fluid via the measuring probe, wherein the measuring sensor is connected to the measuring chamber for measuring at least one fluid parameter.

Upon using such a protective housing, the data registration device may be attached to the inside of the well pipe or to the outside of the well pipe.

If arranged on outside the protective housing, at least one of the measuring sensor and the data registration device may be attached to the inside of the well pipe or in the outside of the housing.

Further, at least one of the measuring sensor and the data registration device, at least parts of the data registration device, may be releasably attached so as to allow it/them to be removed or replaced; which is similar to that described hereinbefore. Thus, at least one data storage medium, for example a memory chip, may be releasably attached.

The at least one measuring sensor in the data gathering device may be structured for measuring at least one of the following formation-associated parameters:
fluid pressure;
temperature;
electric parameters;
electromagnetic parameters;
acoustic parameters;
nuclear parameters;
fluid density; and
fluid composition.

Based on such measurements, it will also be possible to calculate derived parameters, for example fluid flow rates.

Further, the data gathering device may be connected to a well pipe, for example a casing, liner, production tubing or injection tubing.

Even though these types of pipe structures are most common in a well, the data gathering device may just as well be connected to any type of pipe structure in the well.

Moreover, the above-mentioned components and equipment of the data gathering device may be combined in any manner suitable for the particular well situation.

In other respects, the present method may also comprise, between steps (D) and (E), a step of introducing a liquefied fixation means between the well pipe and the borehole wall, and in a region including the data gathering device. Thus, the data gathering device may be fixed in the well.

Although said fixation means typically will be comprised of cement slurry, another type of fixation means may just as well be used, for example a fluidized mixture of particulate matter pumped into the annulus between the well pipe and the borehole wall.

Hereinafter, non-limiting exemplary embodiments of a data gathering device according to the invention will be shown.

### SHORT DESCRIPTION OF THE FIGURES OF THE EXEMPLARY EMBODIMENTS

FIG. 1-9 show a section through an open borehole region of a well, wherein a casing having an integrated or external stabilizer placed in said borehole region, and wherein said data gathering device is connected to the stabilizer.

Three different embodiments of the present data gathering device are shown in the figures, where:

FIGS. 1-3 show a first data gathering device according to the invention comprising a low-pressure chamber connected to a seal plug and an electric magnet coil;

FIGS. 4-6 show a second data gathering device according to the invention comprising an open cylinder provided with a piston and connected to an electric magnet coil; and

FIGS. 7-9 show a third data gathering device according to the invention comprising an open cylinder provided with a piston and a piston rod made of shape-memory metal.

Each of these embodiments is depicted through three snapshots showing successive steps of the installation of the data gathering device in the borehole, however before initiating gathering of formation data from the borehole wall. The three successive snapshots show the following:
(1) The data gathering device before activation and setting of its measuring probe;
(2) The data gathering device after setting of the measuring probe, but before activation of a release mechanism initiating suction of contaminations, i.e. mud cake and contaminated well fluid, from the borehole wall and onwards to a suction chamber; and
(3) Influx of said contaminations into the suction chamber after activation of the release mechanism.

The figures are very simplified and show only essential elements of the well and the data gathering device. The shapes, relative dimensions and mutual positions of the elements are also strongly distorted. Hereinafter, identical, equivalent or corresponding details in the figures will be given substantially the same reference numerals.

### DESCRIPTION OF THE EXEMPLARY EMBODIMENTS

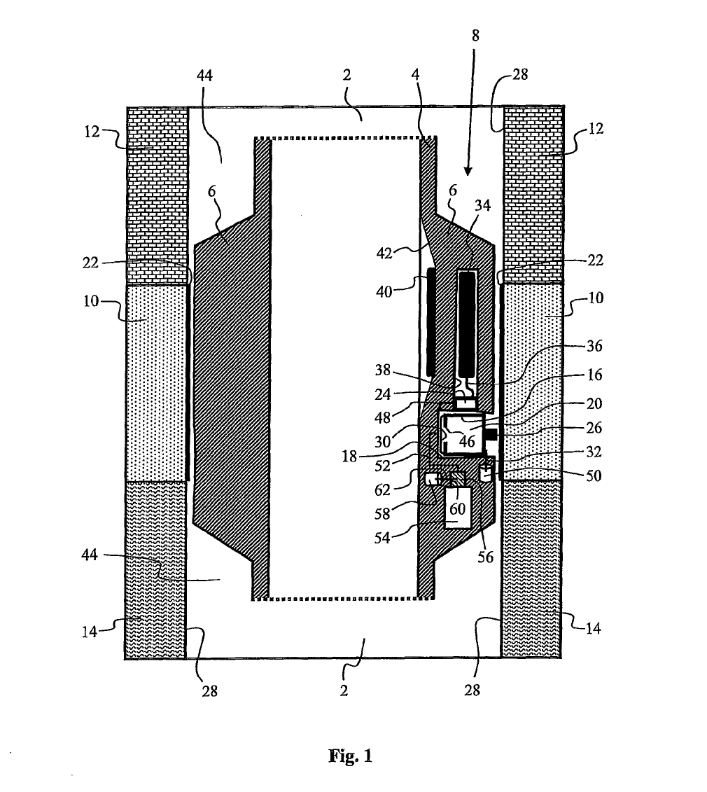

All of FIGS. 1-9 show an open region of a borehole 2 in a well. A casing 4 having an integrated or external stabilizer 6 is placed in this region of the borehole 2, the figures showing only a segment of the casing 4 and its stabilizer 6. A data gathering device 8, 8′ and 8″ according to a respective first, second and third embodiment of the invention is disposed in connection with the stabilizer 6. For the sake of simplicity, only one data gathering device is shown disposed in the stabilizer 6. If desirable or required, the stabilizer 6 may also comprise several such data gathering devices. The stabilizer 6 is placed vis-à-vis a porous and permeable reservoir formation 10, and between two underground formations 12 and 14 having lower porosity and permeability. Here, the stabilizer 6 forms a protective housing for parts of the data gathering device 8, 8′, 8″. In other embodiments, an annular packer, a jacket, a bulb or similar device may just as well be used as such a protective housing.

In these three embodiments, the data gathering device 8, 8′, 8″ is structured for measuring the fluid pressure of the reservoir formation 10, i.e. the pore pressure in the reservoir formation 10. Therefore, the data gathering device 8, 8′, 8″ comprises a radially movable, relative to the longitudinal direction of the well, and sleeve-shaped measuring element 16 disposed in a cylindrical cavity 18 in the stabilizer 6. All of the figures show a section through the measuring element 16. This measuring element 16 includes an internal measuring chamber 20 structured for receiving reservoir fluid from the reservoir formation 10. At its inner end, the measuring chamber 20 is provided with an opening 46 into an inner region of the cavity 18. Via a first flow channel 48, this inner region of the cavity 18 is flow-connected to a separate pressure sensor 24 for measuring said pore pressure. The pressure sensor 24 is disposed in an axially extending storage cavity 38 in the stabilizer 6.

The measuring element 16 also includes flow-through measuring probe 25 flow-connected to the measuring chamber 20 and protruding radially out towards the wall 28 of the borehole 2 for allowing it to establish contact therewith and thus the reservoir formation 10.

Further, the data gathering device 8, 8′, 8″ comprises an activation device including a biasing means and a release means for releasing the biasing means. In these exemplary embodiments, the biasing means is comprised of a spiral spring 30, whereas the release means comprises an operating body in the form of a latch pin 32 of a suitable material, and also a movable magnet (not shown) operatively connected to an electric, first magnet coil 50 disposed in the stabilizer 6. The spiral spring 30, which is shown very schematically in the figures, is disposed in said cylindrical cavity 18, and between the measuring element 16 and the casing 4. The latch pin 32 extends into the cavity 18 and is attached to the movable magnet so as to allow it to be moved upon electrical activation of the magnet coil 50.

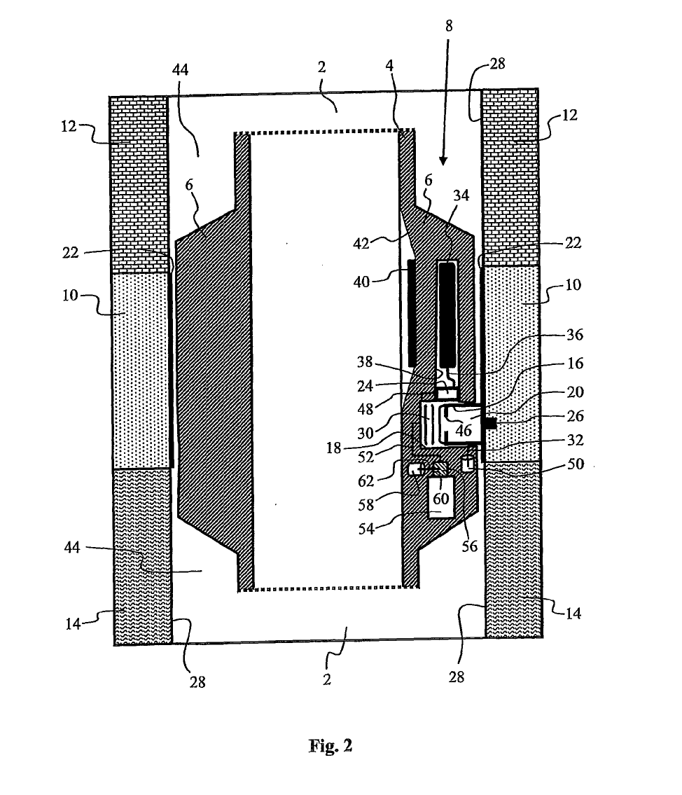

Further, FIGS. 1, 4 and 7 show the spiral spring 30 in a compressed position due to the measuring element 16 having been forced in towards the spring 30, and due to the latch pin 32 extending in front of the measuring element 16 and holding it in place in an inactive, retracted position of rest within the cavity 18. FIGS. 2, 5 and 8, however, show the measuring element 16 in an extended, active data gathering position after electrical activation of the first magnet coil 50. Remaining equipment for operation and/or control of the coil 50 may comprise equipment as described hereinbefore, but such equipment is not shown in the figures. Upon such activation, said magnet moves towards the coil 50 and pulls the latch pin 32 along in the same direction, whereby the latch pin 32 is liberated from the measuring element 16. Due to this withdrawal of the latch pin 32, the spiral spring 30 will, by virtue of its stored spring energy, drive the measuring element 16 and its measuring probe 26 radially outwards until contact with the borehole wall 28 and the reservoir formation 10. In this manner, hydraulic contact is achieved between the reservoir formation 10 and the measuring chamber 20, as shown in FIGS. 2, 5 and 8.

As an alternative, the latch pin 32 may be comprised of a soluble material, for example aluminium, attached to the stabilizer 6 and extending into the cavity 18 in front of the measuring element 16 so as to hold it in place in its retracted position of rest. Through dissolution of the latch pin 32, the spring energy of the spiral spring 30 is liberated and drives the measuring element 16 and the measuring probe 26 outwards until contact with the borehole wall 28 and the reservoir formation 10. For example, dissolution of the latch pin 32 may be carried out by introducing an acid into the borehole 2 upon having positioned the gathering device 8, 8′, 8″ vis-à-vis the reservoir formation 10.

In order to prevent undesirable liquid and particles, for example drilling fluid containing drill cuttings, from entering into the measuring chamber 20 before the measuring element 16 has been placed in its active data gathering position, the measuring chamber 20 may be filled with an easily fusible and easily dissolvable material, for example bitumen, wax or sugar. First, this easily fusible/easily dissolvable material will melt/dissolve upon having forced the measuring probe 26 of the measuring element 16 into the borehole wall 28. Thereby, a flow connection between the measuring chamber 20 and the reservoir formation 10 will be established. Such easily fusible/easily dissolvable material is not shown in the figures.

The data gathering device 8, 8′, 8″ also comprises a data registration device including a data registration unit 34 to which said pressure sensor 24 is connected via a flexible cable 36. The data registration unit 34 is disposed in said storage cavity 38 in the stabilizer 6. This data registration unit 34 includes required electronic components and equipment, including a suitable processor with an associated data program, a data converter, wireless signal transmission equipment, at least one battery, and also various couplings, wires, gaskets and similar (not shown in the figures). In these exemplary embodiments, the data registration device also includes a data storage medium in the form of a memory chip 40 releasably attached in an axially extending groove 42 on the inside of the casing 4. Via a wireless radio frequency connection, the data registration unit 34 transmits regular fluid pressure data to the memory chip 40. Thereby it is possible, for example through a cable-assisted well intervention, to carry out a periodical withdrawal and replacement of the memory chip 40. In this context, various known devices, equipment and methods exist for allowing such a withdrawal and replacement to be carried out.

Upon having brought the measuring probe 26 of the data gathering device 8, 8′, 8″ into contact with the borehole wall 28 and the reservoir formation 10, a suction chamber according to the invention is activated in order to suck in contaminations 22 of the above-mentioned types from the borehole wall 28 before the gathering of formation data is initiated. On the figures the contaminations 22 are shown as a mud filtrate covering the borehole wall 28 located vis-à-vis the reservoir formation 10. The contaminations 22 also comprise mud permeate and/or another well liquid (not shown) which has penetrated into the borehole wall 28 and have contaminated the original formation fluid in the reservoir formation 10.

As will be described in further detail below, the suction chamber is disposed in the stabilizer 6 and is structured in a manner allowing it to carry out a non-forced and non-motorized suction of the contaminations 22 from the borehole wall 28. In this context, said contaminations 22 will flow via the measuring probe 26, the measuring chamber 20, the opening 46 and into said inner region of the cavity 18. In order to be able to transport the contaminations 22 further, a second flow channel 52 is disposed between the suction chamber and the inner region of the cavity 18.

Reference is now made to the first data gathering device 8 according to FIGS. 1-3.

The data gathering device 8 comprises a suction chamber in the form of a temporarily sealed low-pressure chamber 54. This chamber 54 is connected to a pressure isolation means in the form of a seal plug 56, and also a release means comprising, among other things, an electric, second magnet coil 58 disposed in the stabilizer 6. This magnet coil 58 and associated equipment (not shown) operate in the same manner as that of the first magnet coil 50.

The low-pressure chamber 54 is provided with atmospheric air and thus has a lower pressure than the formation pressure at the borehole wall 28. For maintenance of the atmospheric air pressure in the chamber 54, the seal plug 56 is disposed in a recess 60 at the upstream end of the chamber 54 so as to seal the second flow channel 52 against through-put onwards to an inlet of the low-pressure chamber 54.

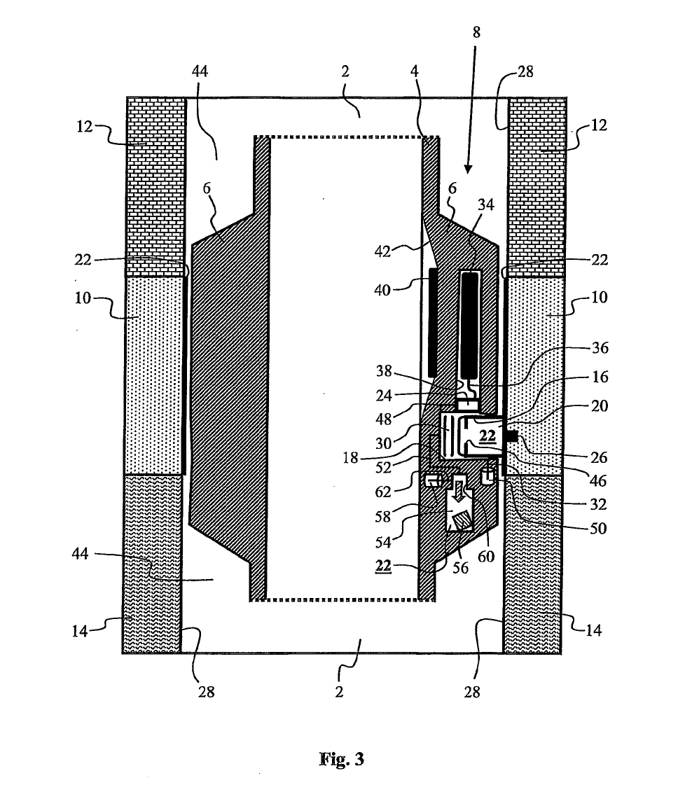

The release means also comprises an operating body in the form of a latch pin 62 connected to a movable magnet (not shown) operatively connected to the magnet coil 58. The latch pin 62 is releasably connected to the seal plug 56 and holds it in place in the recess 60, as shown in FIGS. 1 and 2. Upon electrical activation of the magnet coil 58, said magnet moves towards the coil 58 and pulls the latch pin 62 out of its engagement with the seal plug 56. Due to the lower pressure in the low-pressure chamber 54, the seal plug 56 is sucked into the low-pressure chamber 54 and opens to flow of said contaminations 22 through the second flow channel 52 and into the this chamber 54, as shown in FIG. 3. Then the gathering of formation data from the borehole wall 28, and hence from the reservoir formation 10, may be initiated.

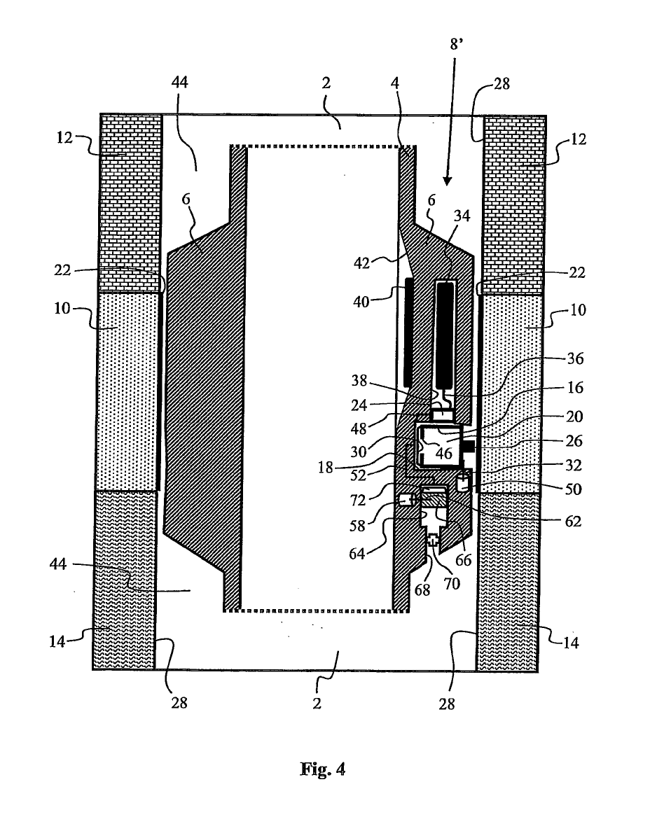

Reference is now made to the second data gathering device 8′ according to FIGS. 4-6.

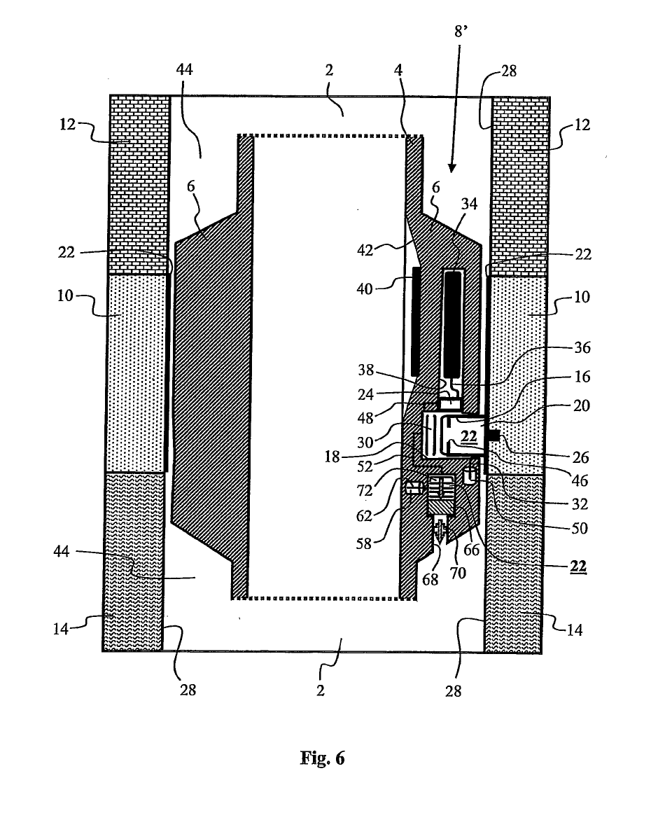

The data gathering device 8′ comprises a suction chamber in the form of a cylinder 64 provided with a piston 66 movably arranged within the cylinder 64. A downstream end portion of the cylinder 64 is open to discharge via a discharge channel 68 leading out to the borehole 2. Further, the discharge channel 68 is provided with a flow delay means in the form of a flow-through nozzle 70 providing for a more even flow out of the cylinder 64 when the piston 66, upon activation, is moved in the downstream direction. This discharge via the nozzle 70 is indicated with a hachured arrow in FIG. 6. Due to this movement of the piston 66, said contaminations 22 are sucked in at the upstream side of the cylinder 64 via said second flow channel 52.

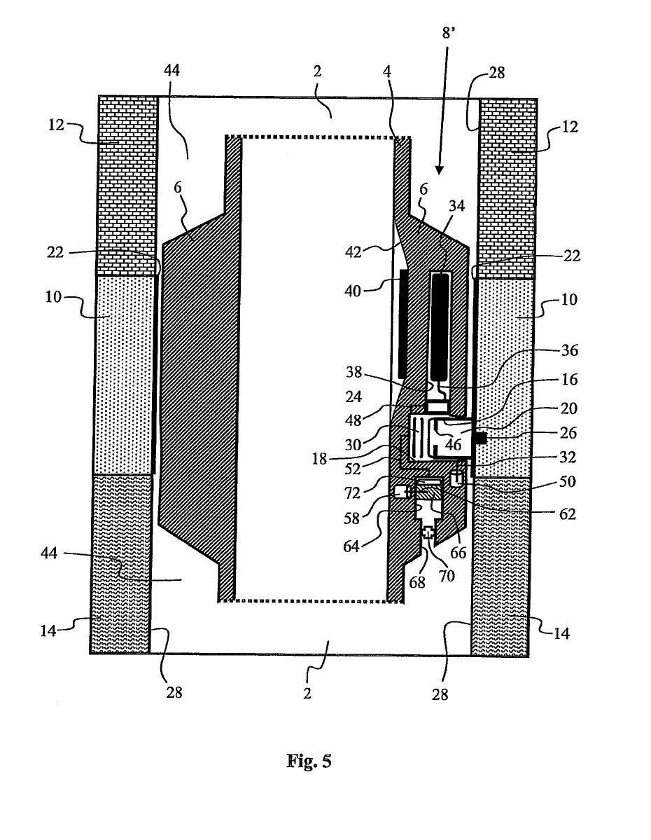

Further, an upstream end portion of the cylinder 64 is provided with a biasing means in the form of a spiral spring 72 bearing in a biasing manner against the upstream side of the piston 66, as shown in FIGS. 4 and 5. In this position, the piston 66 is releasably connected to a release means comprising a latch pin 62 connected to a movable magnet (not shown). The magnet is operatively connected to a magnet coil 58 disposed in the stabilizer 6; which is similar to the preceding exemplary embodiment. The mode of operation of the release means is also described in the preceding exemplary embodiment, and the magnet coil 58 and associated equipment (not shown) operate in the same manner as that of the first magnet coil 50. Upon electrical activation of the magnet coil 58, the magnet moves towards the coil 58 and pulls the latch pin 62 out of its engagement with the piston 66. This release liberates the biasing force in the spiral spring 72 so as to drive the piston 66 in a downstream direction within the cylinder 64. By so doing, also the contaminations 22 are sucked into the cylinder 64 via said second flow channel 52, as shown in FIG. 6. The gathering of formation data from the borehole wall 28, and hence from the reservoir formation 10, may then be initiated.

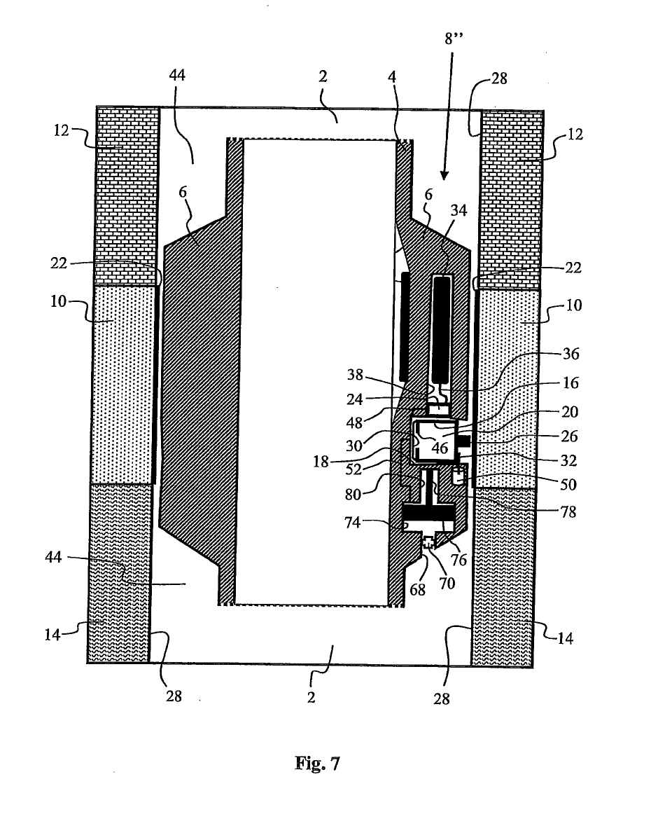

Reference is now made to the third data gathering device 8″ according to FIGS. 7-9.

Also this data gathering device 8″ comprises a suction chamber in the form of a cylinder 74 provided with a piston 76 movably arranged within the cylinder 74. Contrary to the piston 66 according to the preceding exemplary embodiment, an upstream side of the piston 76 is connected to a piston rod 78 formed from a suitable shape-memory material, for example a shape-memory metal. This shape-memory material is structured in a manner allowing it to be activated and extended upon reaching a temperature corresponding to the formation temperature at the particular data gathering region of the borehole wall 28. Upon temperature activation, such shape-memory materials may be extended substantially, possibly in the order of 10-30%.

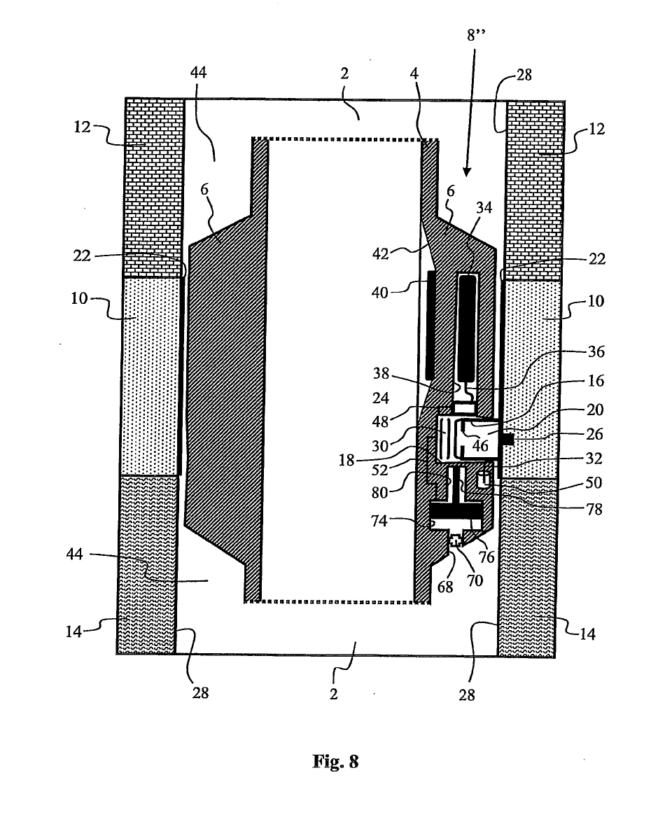

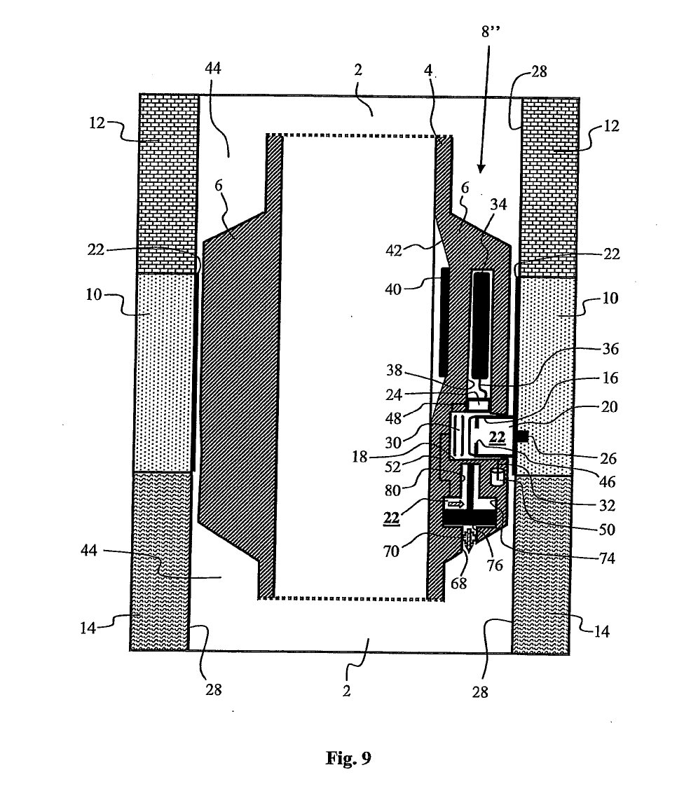

Further, the piston rod 78 is disposed in a recess 80 at the upstream end of the cylinder 74. The piston rod 78 bears against an end wall of the recess 80, whereas said second flow channel 52 continues onwards to an inlet of the cylinder 74. FIGS. 7 and 8 show the piston rod 78 before temperature activation. Upon said temperature activation of the shape-memory material, the piston rod 78 will extend, possibly 10-30%, and move the piston 76 in the downstream direction. Thus, this temperature activation constitutes a release means for the piston 76. The movement of the piston 76 ensures that said contaminations 22 are sucked in at the upstream side of the cylinder 74 via the recess 80 and the second flow channel 52, as shown in FIG. 9. In order to compensate for a relatively short movement of the piston 76 within the cylinder 74, the cylinder 74 has a relatively large diameter as compared to the cylinder 64 according to the preceding exemplary embodiment.

Similar to the preceding exemplary embodiment, a downstream end portion of the cylinder 74 is open to discharge via a discharge channel 68 leading out to the borehole 2. Further, the discharge channel 68 is provided with a flow-delaying nozzle 70 providing for a more even flow out of the cylinder 74 when the piston 76, upon activation, moves in the downstream direction. This discharge via the nozzle 70 is indicated with a hachured arrow in FIG. 9.

Upon having placed the data gathering device 8, 8′, 8″ in its active data gathering position in the well, the method according to the second aspect of the invention may comprise a step of pumping a cement slurry or a fluidized mixture of particulate matter into an annulus 44 between the casing 4 and the borehole wall 28. Thereby the data gathering device 8, 8′, 8″, among other things, may be fixed in the well.

1. Data gathering device for a well pipe, wherein the data gathering device is connected to the well pipe and is structured for in situ gathering of formation data from a borehole wall of a well in an open borehole, and wherein the data gathering device comprises:
at least one movable measuring probe structured to be movable at least out from the well pipe to be able to establish contact with the borehole wall;
at least one activation device structured in a manner allowing it to cause said measuring probe movement;
at least one measuring sensor which, for measuring at least one formation-associated parameter, is connected to the measuring probe; and
at least one data registration device which, for registration of measured parameters, is connected to the measuring sensor, wherein the data gathering device also comprises at least one suction chamber hydraulically connected to the measuring probe;
wherein the suction chamber is structured in a manner allowing it to carry out non-motorized suction of contaminations from the borehole wall before the gathering of formation data is initiated;
wherein the suction chamber is connected to a release means for controlled activation of said suction; and
wherein at least the measuring probe, the activation device and the suction chamber are disposed hydraulically isolated from the inside of the well pipe.

2. The data gathering device according to claim 1, wherein the suction chamber is comprised of a low-pressure chamber provided with a compressible medium arranged with a lower pressure than the particular formation pressure at the borehole wall;
wherein a pressure isolation means is disposed between the low-pressure chamber and the measuring probe for maintenance of the lower pressure in the low-pressure chamber; and
wherein a release means is connected to the pressure isolation means for controlled liberation of the pressure isolation means;
this liberation providing for pressure communication between the low-pressure chamber and the measuring probe so as to bring about suction of contaminations from the borehole wall and into the low-pressure chamber.

3. The data gathering device according to claim 2, wherein the pressure isolation means is comprised of a movable seal plug sealing off an inlet to the low-pressure chamber.

4. The data gathering device according to claim 3, wherein the release means comprises an electric coil operatively connected to a movable magnet;
wherein the magnet is connected to an operating body releasably connected to the seal plug for controlled holding and liberation of the seal plug; and
wherein the electric coil, upon activation, is structured in a manner allowing it to move the magnet and the operating body away from the seal plug for liberation of the seal plug.

5. The data gathering device according to claim 2, wherein the pressure isolation means is comprised of a seal sealing off an inlet to the low-pressure chamber.

6. The data gathering device according to claim 5, wherein the release means comprises an electric coil operatively connected to a movable magnet;
wherein the magnet is connected to an operating body provided with a puncturing means for the seal;
wherein the puncturing means is disposed in vicinity of the seal; and
wherein the electric coil, upon activation, is structured in a manner allowing it to move the magnet and hence the puncturing means of the operating body towards the seal for puncturing of the seal.

7. The data gathering device according to claim 5, wherein the release means comprises a movable operating body formed from a shape-memory material;
wherein the operating body is provided with a puncturing means for the seal;
wherein the puncturing means is disposed in vicinity of the seal; and
wherein the shape-memory material is structured in a manner allowing it to be activated and extended upon reaching a temperature corresponding to the particular formation temperature at the borehole wall;
this extension of the operating body causing the puncturing means to puncture the seal.

8. The data gathering device according to claim 2, wherein the compressible medium is comprised of air.

9. The data gathering device according to claim 1, wherein the suction chamber is comprised of a cylinder provided with a piston movably arranged within the cylinder;
wherein a downstream end portion of the cylinder is open to discharge;
wherein an upstream end portion of the cylinder is provided with a biasing means connected in a biasing manner to an upstream side of the piston; and
wherein a release means is releasably connected to the piston for controlled holding and liberation of the piston;
this liberation causing a biasing force in the biasing means to drive the piston in a downstream direction within the cylinder so as to bring about suction of contaminations from the borehole wall and into the cylinder.

10. The data gathering device according to claim 9, wherein the release means comprises an electric coil operatively connected to a movable magnet;
wherein the magnet is connected to an operating body releasably connected to the piston for controlled holding and liberation of the piston; and
wherein the electric coil, upon activation, is structured in a manner allowing it to move the magnet and hence the operating body away from the piston for liberation of the piston.

11. The data gathering device according to claim 9, wherein the release means comprises a movable operating body formed from a shape-memory material;
wherein the operating body is releasably connected to the piston for controlled holding and liberation of the piston; and
wherein the shape-memory material is structured in a manner allowing it to be activated and change the shape of the operating body to a piston-liberating shape upon reaching a temperature corresponding to the particular formation temperature at the borehole wall.

12. The data gathering device according to claim 1, wherein the suction chamber is comprised of a cylinder provided with a piston movably arranged within the cylinder;
wherein a downstream end portion of the cylinder is open to discharge;
wherein an upstream side of the piston is connected to a piston rod formed from a shape-memory material; and
wherein the shape-memory material is structured in a manner allowing it to be activated and extended upon reaching a temperature corresponding to the particular formation temperature at the borehole wall;
this temperature activation constituting a release means causing the piston rod to be extended so as to drive the piston in a downstream direction within the cylinder and thus bring about suction of contaminations from the borehole wall and into the cylinder.

13. The data gathering device according to claim 1, wherein the measuring probe and the suction chamber are disposed in a protective housing connected to the well pipe; and
wherein the measuring probe is structured to be movable at least out of the housing for contact with the borehole wall.

14. The data gathering device according to claim 13, wherein at least one of the activation device, the measuring sensor and the data registration device is disposed in the housing.

15. A method of removing, in an open borehole, contaminations from a borehole wall of a well before initiating in situ gathering of formation data from the borehole wall, wherein the method comprises:
(A) providing a well pipe with a data gathering device comprising at least one movable measuring probe, at least one activation device connected to the measuring probe, at least one measuring sensor connected to the measuring probe, and at least one data registration device connected to the measuring sensor;
(B) inserting the well pipe and the data gathering device into the well and down to a data gathering region of the open borehole;
(C) for gathering of formation data, placing the data gathering device in a desired position in said region of the borehole;
(D) activating said activation device and moving said measuring probe in a direction out from the well pipe and into the borehole wall for contact therewith;
(E) with said measuring sensor, measuring at least one formation-associated parameter; and
(F) with said data registration device, registering measured parameters from the measuring sensor, wherein the method also comprises:
in step (A), providing the well pipe with a data gathering device according to claim 1; and
between steps (D) and (E), releasing the release means of the data gathering device so as to initiate a non-motorized suction of contaminations from the borehole wall.
